(19) United States
(12) Patent Application Publication
(10) Pub. No.: US 2019/0309831 A1
(43) Pub. Date: Oct. 10, 2019

(54) HYDRAULIC TENSIONER ARM MOUNTING WITH LEVER

(71) Applicant: BorgWarner Inc., Auburn Hills, MI (US)

(72) Inventors: Keith B. COBB, Cortland, NY (US); Mark WIGSTEN, Lansing, NY (US); Kevin TODD, Freeville, NY (US); XiaoJian LU, Shanghai (CN); Seongdo HONG, Ithaca, NY (US); Paul FREEMANTLE, Lansing, NY (US); Akira TAKEUCHI, Nabari (JP)

(21) Appl. No.: 16/378,860

(22) Filed: Apr. 9, 2019

Related U.S. Application Data
(60) Provisional application No. 62/654,757, filed on Apr. 9, 2018.

(51) Int. Cl. F16H 7/08; F16H 25/18

(52) U.S. Cl. CPC F16H 7/08; F16H 7/0848; F16H 25/18; F16H 2007/0893; F16H 2007/0872; F16H 2007/0859; F16H 2007/0812

(57) ABSTRACT

Hydraulic tensioner device including a tensioner arm and a hydraulic tensioner. The tensioner arm comprising: a body having a first end, a second end, a chain sliding surface and a surface opposite the chain sliding face; a pivot at the first end or the second end of the body; and a banjo bolt feed at the other of the first end or second end of the body. The hydraulic tensioner being pivotably attached to the pivot and the banjo bolt and adjacent the surface opposite the chain sliding face, wherein the hydraulic tensioner receives supply fluid from the banjo bolt, the hydraulic tensioner comprising: a housing with a bore; a hollow piston having a first end and a second end, slidably received within the bore; and a spring received within the bore of the housing and the hollow piston biasing the hollow piston outwards from the bore of the housing.

### CROSS-REFERENCE TO RELATED APPLICATIONS

This application claims the benefit of U.S. Patent Application No. 62/654757 filed on Apr. 9, 2018, the disclosure of which is herein incorporated by reference in its entirety.

### BACKGROUND OF THE INVENTION

### Field of the Invention

The invention pertains to the field of hydraulic tensioners. More particularly, the invention pertains to a hydraulic tensioner arm mounting with a lever.

### Description of Related Art

A hydraulic tensioning device for a chain system generally includes a tensioner arm to apply tension to a chain or belt to keep the chain from becoming loose in cases such as becoming worn, or if other parts of an engine move such that slack results in the chain or belt. The hydraulic tensioner devices require replacement of oil (or other lubricating fluid) as the oil leaks out of the device over time. Due to the leakage of oil from the tensioner device, at least one reservoir is connected to the tensioner device to supply replacement oil thereto. FIG. 1 illustrates a conventional tensioner device 100 that includes a reservoir 101 formed into a back portion thereof to store replacement oil.

### SUMMARY OF THE INVENTION

According to one embodiment of the present invention, a hydraulic tensioner device for an internal combustion engine is disclosed. The hydraulic tensioner device comprising: a tensioner arm and a hydraulic tensioner. The tensioner arm comprising: a body having a first end, a second end, a chain sliding surface and a surface opposite the chain sliding face; a pivot at the first end or the second end of the body; and a banjo bolt feed at the other of the first end or second end of the body. The hydraulic tensioner being pivotably attached to the pivot and the banjo bolt and adjacent the surface opposite the chain sliding face, wherein the hydraulic tensioner receives supply fluid from the banjo bolt, the hydraulic tensioner comprising: a housing with a bore; a hollow piston having a first end and a second end, slidably received within the bore; and a spring received within the bore of the housing and the hollow piston biasing the hollow piston outwards from the bore of the housing.

According to another embodiment of the present invention, a hydraulic tensioner device for an internal combustion engine is disclosed. The hydraulic tensioner device comprising: a tensioner arm comprising: a body having a first end, a second end, a chain sliding surface, a surface opposite the chain sliding face providing a housing having a bore; and a pivot at the first end or the second end of the body; and a hydraulic tensioner comprising a hollow piston having a first end and a second end, slidably received within the bore of the housing of the body of the tensioner; and a spring received within the bore of the housing and the hollow piston biasing the hollow piston outwards from the bore of the housing.

According to another embodiment of the present invention, a hydraulic tensioner device for an internal combustion engine is disclosed. The hydraulic tensioner device comprising: a tensioner arm and a hydraulic tensioner. The tensioner arm comprising: a body having a first end, a second end, a chain sliding surface, a surface opposite the chain sliding face; and a pivot at the first end or the second end of the body. The hydraulic tensioner rigidly attached to the internal combustion engine, the hydraulic tensioner comprising: a housing having an extension and a bore, the bore and the extension being parallel; a hollow piston having a first end and a second end, slidably received within the bore of the housing; a spring received within the bore of the housing and the hollow piston biasing the hollow piston outwards from the bore of the housing; and a rotatable cam lever pivotably attached to the extension, the cam lever having a first edge for contacting the first end of the hollow piston and a second end for contacting the surface opposite the chain sliding surface of the tensioner arm at the first end or second end with the pivot, the rotatable cam lever being rotatable by the hollow piston, such that the rotatable cam lever biases the tensioner arm to pivot into contact with a chain.

According to another embodiment, a hydraulic tensioner device for an internal combustion engine is disclosed. The hydraulic tensioner device comprising: a tensioner arm and a hydraulic tensioner, where the hydraulic tensioner is strapped to a surface of the tensioner arm opposite the chain sliding surface of the tensioner arm.

In other embodiments, the hydraulic tensioner device can include a no oil feed tensioner or an oil feed (hydraulic) tensioner in which the oil is supplied from a reservoir within the tensioner arm itself or fed directly through a pivot point of the tensioner arm.

### BRIEF DESCRIPTION OF THE DRAWINGS

FIG. 1 shows a hydraulic tensioner device used with a tensioner arm and attached reservoir according to conventional designs.

FIG. 2A shows a tensioner device including a tensioner arm and a hydraulic tensioner combination according to an embodiment of the present invention.

FIG. 2B shows the hydraulic tensioner device of FIG. 2A being applied to a new chain.

FIG. 2C shows the hydraulic tensioner device of FIG. 2A being applied to a worn chain.

FIG. 2D shows a top view of the hydraulic tensioner device 200 of FIG. 2A.

FIG. 2E shows a sectional view of FIG. 2A.

FIG. 2F shows an example of an oil feed banjo bolt.

FIG. 2G shows an alternate embodiment of FIG. 2A in which the tensioner is a sealed, no oil feed tensioner.

FIG. 3A shows a hydraulic tensioner device including a tensioner arm covered by a laminate, according to another embodiment of the present invention.

FIG. 3B shows the hydraulic tensioner device exposing the tensioner arm.

FIG. 4 shows a hydraulic tensioner device including a tensioner arm and a tensioner combination, according to another embodiment of the present invention.

FIG. 5A shows a cross-sectional view of a hydraulic tensioner device including a tensioner arm and tensioner combination, according to still another embodiment of the present invention.

FIG. 5B shows a cross-sectional view of the tensioner device of FIG. 5A.

FIG. 5C shows a cross-section of an alternate tensioner incorporated into the tensioner arm.

FIG. 6A shows a hydraulic tensioner device assembly according to another embodiment of the present invention with the piston in a first position for tensioning a new chain.

FIG. 6B illustrate a hydraulic tensioner device assembly according to another embodiment of the present invention with the piston in a second, extended position for tensioning a worn chain.

FIG. 6C shows the hydraulic tensioner of FIG. 6A in contact with a tensioner arm tensioning a new chain.

FIG. 6D shows the hydraulic tensioner of FIG. 6B in contact with a tensioner arm for tensioning a worn chain.

FIG. 7 shows a side view of a hydraulic tensioner device according to another embodiment.

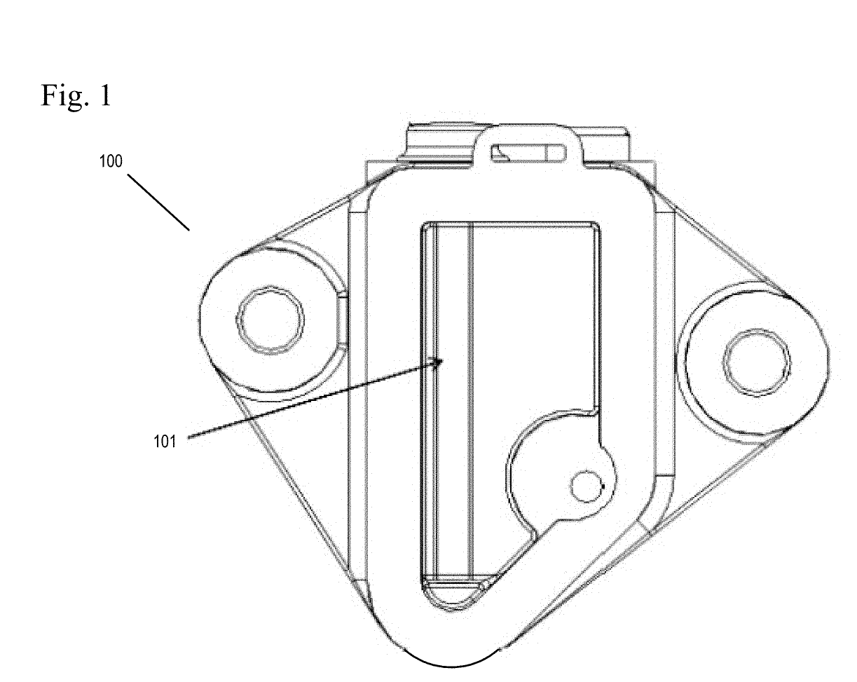

### DETAILED DESCRIPTION OF THE INVENTION

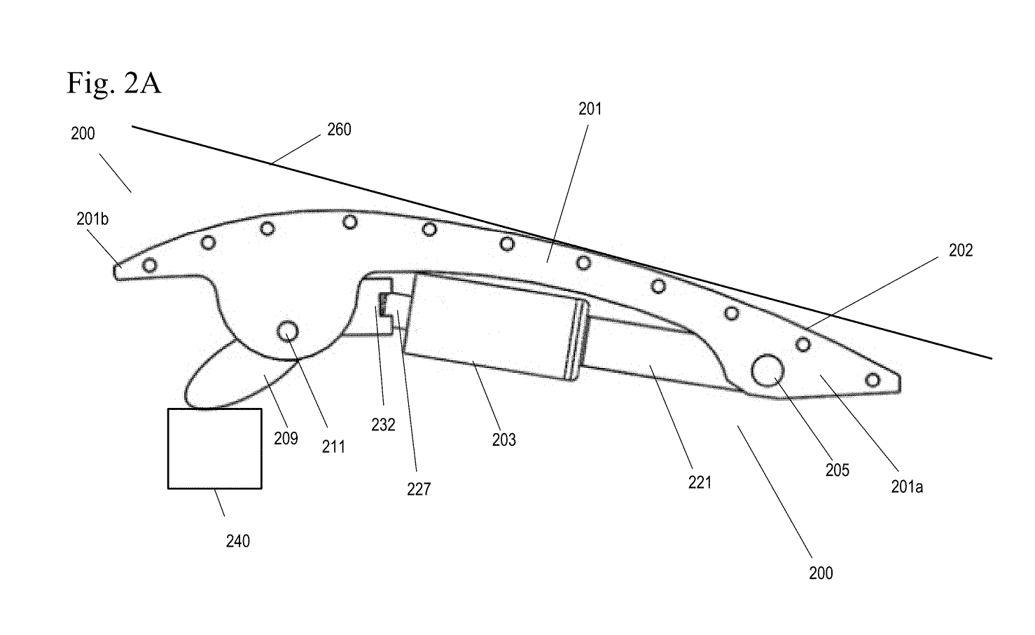

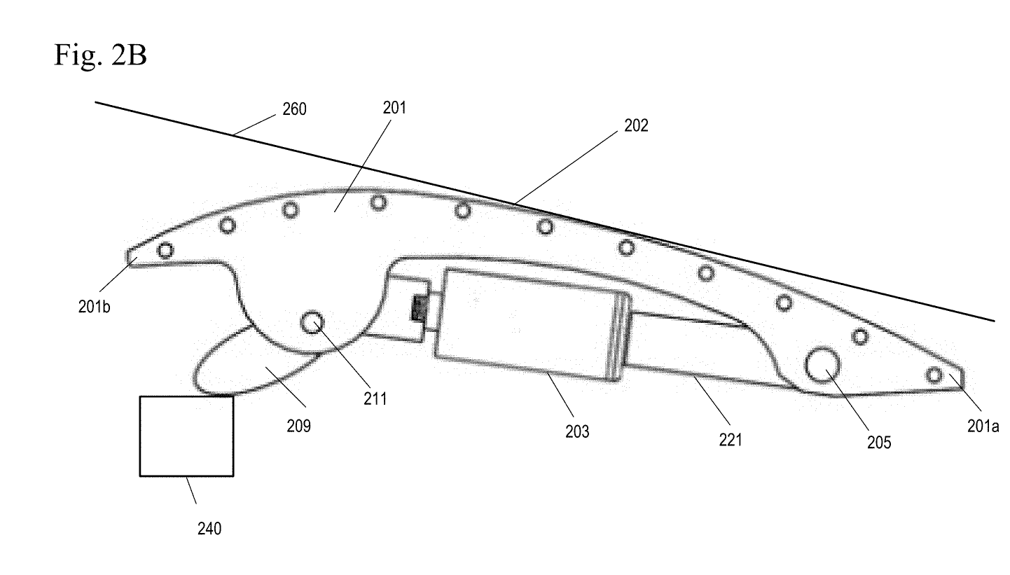

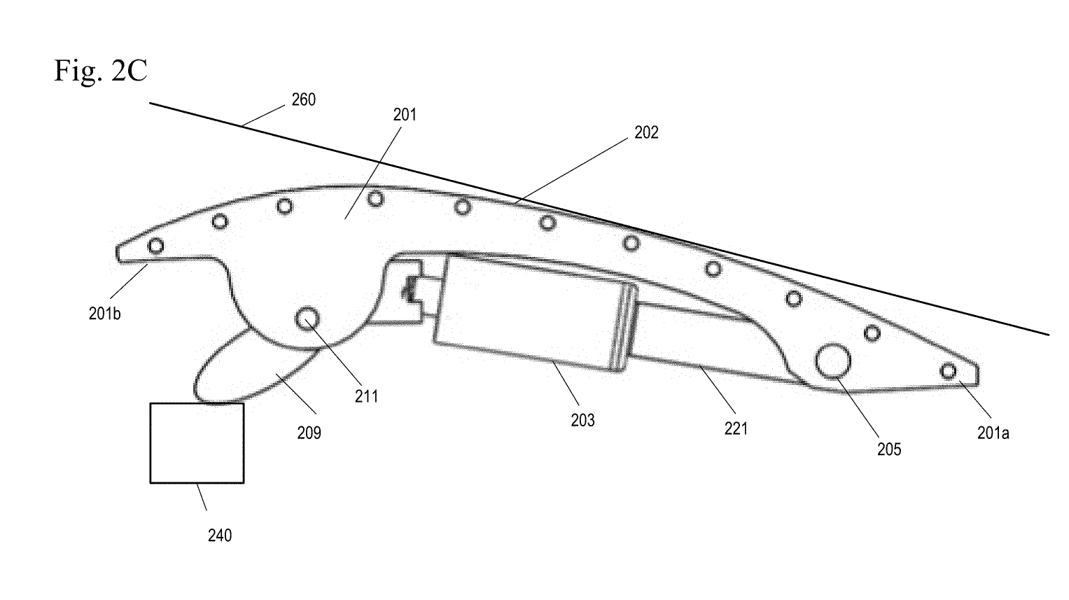

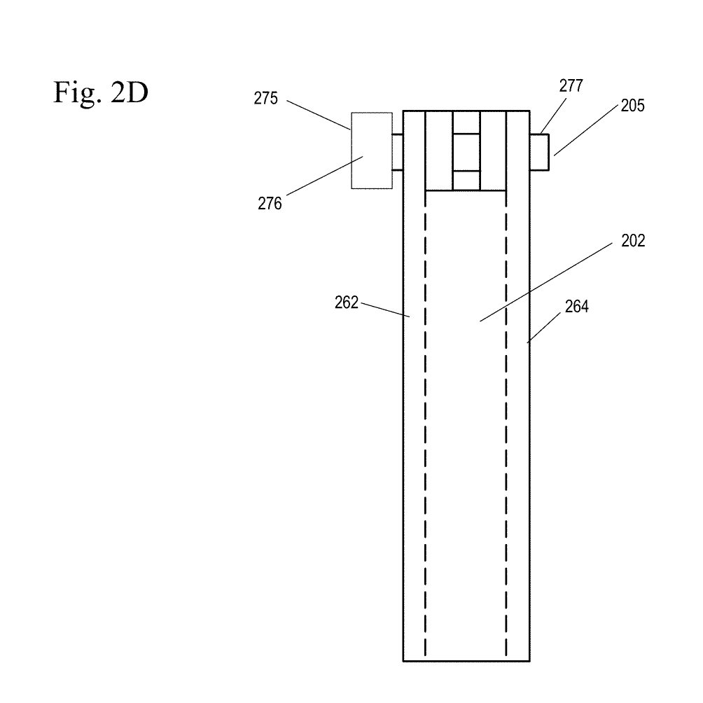

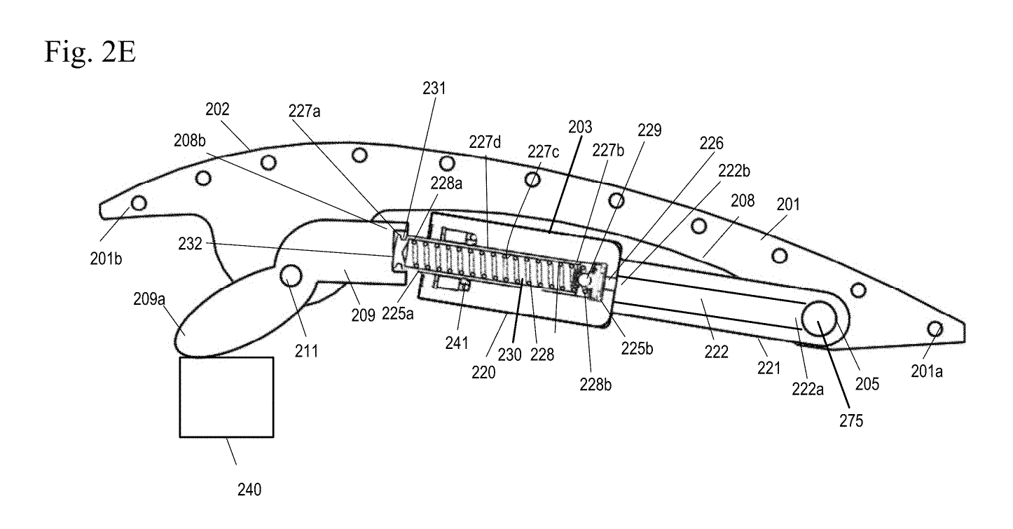

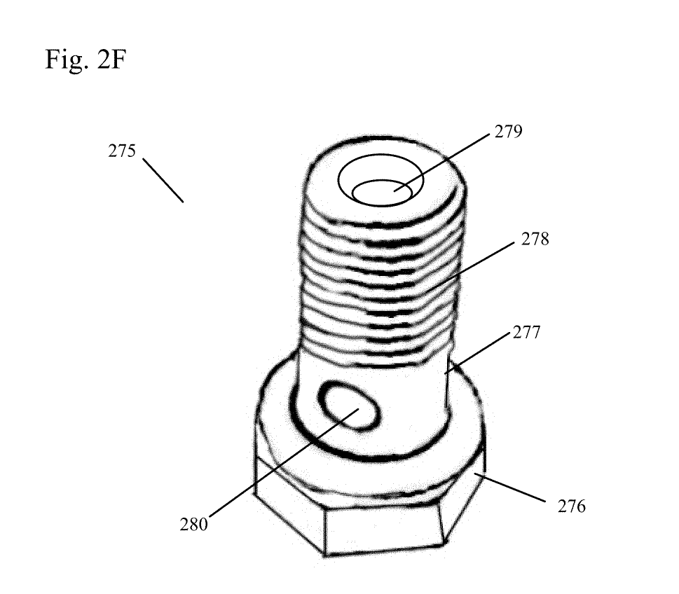

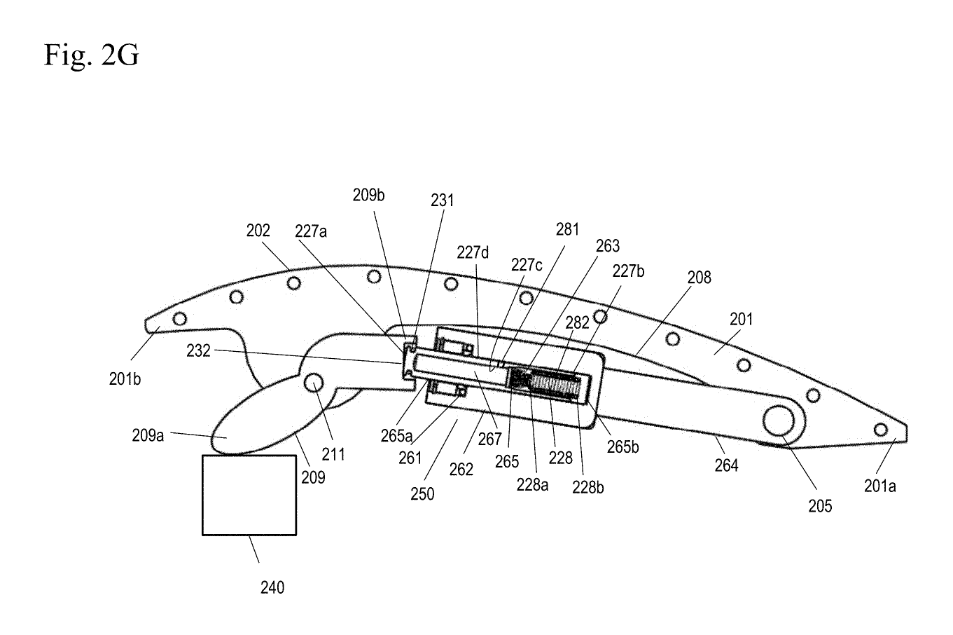

FIGS. 2A-2F show a hydraulic tensioner device 200 including a tensioner arm 201 and a hydraulic tensioner 203. The tensioner arm 201 has a body with an arcuate shape having first end 201a, a second end 201b, a chain sliding surface 202, and a surface 208 opposite the chain sliding surface 202. The first end 201a of the tensioner arm 201 receives a first pivot point 205 and the second end of the tensioner arm 201b has a second pivot point 211.

In one embodiment, shown in FIGS. 2A-2F, the first pivot point 205 can be an oil feed banjo bolt 275. An oil feed banjo bolt 275 (see FIG. 2F) has a head 276 attached to hollow shaft 277. Within the hollow shaft 277 is an inlet oil feed passage 279 which is perpendicular to the head 276. At least one oil feed passage 280 is present within the hollow shaft 277 and is perpendicular to the inlet oil feed passage 279. The outer circumference of the hollow shaft 277 preferably has threads 278. The at least one oil feed passage 280 is connected to an inlet 226 of the hydraulic tensioner 203. The oil feed banjo bolt 275 of the first pivot point 205 allows fluid from a supply (not shown) to flow to the hydraulic tensioner 203 of the hydraulic tensioner device 200.

As shown in FIG. 2D, the tensioner arm 201 may be formed of a first plate 262 and a second plate 264 which are rigidly attached to each other via rivets, pins or other means. The oil feed banjo bolt 275 is shown as the first pivot point 205.

In an alternate embodiment shown in FIG. 2G, the first pivot point 205 includes an ordinary bolt that does not contain or connected to a supply, as the hydraulic tensioner 250 is a no oil feed, sealed tensioner.

Hydraulic tensioner 203 of the hydraulic tensioner device 200 is pivotably attached to the tensioner arm 201 via the first pivot point 205 and the second pivot point 211 of a lever 209. The hydraulic tensioner 203 is attached to the first pivot point 205 via rod 221. The hydraulic tensioner 203 is attached to the second pivot point 211 of the lever 209 by interaction piston 227 of the tensioner with closed end bore 232 of the lever 209.

More specifically, the housing 220 of the hydraulic tensioner 203 has an open ended bore 225 with a first open end 225a and a second end 225b in fluid communication with a supply port 226. The supply port 226 is in fluid communication with cross drilled passage or hole 222 of the rod 221. The passage 222 has a first end 222a and a second end 222b. The first end 222a of the passage 222 is in fluid communication with the oil feed banjo bolt 275 of the first pivot point 205. The second end 222b of the passage 222 are in fluid communication with the supply port 226. Alternatively, oil feed paths can be molded into a plastic tensioner arm 201, depending on the tensioner 203 location to feed oil to the tensioner 203.

A hollow piston 227 is slidably received within the open ended bore 225. The hollow piston 227 has a first end 227a, a second end 227b, an inner hollow 227c, and an outer circumference 227d. The second end 227 of the hollow piston 227 is received within the open ended bore 225. The outer circumference 227d of the first end 227a of the hollow piston 227 has an outer circumferential groove 231. Received within the inner hollow 227c of the piston 227 is a spring 228 which biases the piston 227 outwards or away from the second end 225b of the bore 225. The spring 228 has a first end 228a received within the inner hollow 227c of the piston 227 and a second end 228b adjacent an inlet check valve 229 located at the second end 225b of the bore 225. The inlet check valve 229 prevents fluid from flowing back to the oil feed banjo bolt 275 and allows fluid to flow to a hydraulic pressure chamber 230 formed between the hollow piston 227, the open ended bore 225 and the inlet check valve 229.

Adjacent at least part of the bore 225 within the housing 220 are seals which may be used to guide and surround the outer circumference of the piston 227, as the piston 227 moves relative to the housing 220.

A lever 209 is pivotably attached to the second end 201b of the tensioner arm 201 at a second pivot point 211. The first end 209a of the lever 209 interfaces with a surface 240 of the engine. The second end 209b of the lever 209 has a closed end bore 232 for receiving the first end 227a of the piston 227. The first end 227a of the piston 227 can be captured and maintained within the closed end bore 232 of the lever 209 by the outer circumferential groove 231. Preferably, the first end 227a of the piston 227 is allowed a small amount of play within the closed end bore 232 of the lever 209.

A tension force can be applied to the tensioner arm 201 through mechanical lever 209, rotating the lever 209 about the second pivot point 211. When a force is exerted on the chain sliding surface 202 of tensioner arm 201 by the chain 260, the movement of the tensioner arm 201 moves the piston 227 of the tensioner 203 relative to the housing 220 of the tensioner arm 201, such that the movement of the piston 227 and the associated interaction of the first end 227a of the piston 227 with the closed end bore 232 of the lever 209, causes the lever 209 to pivot about the second pivot point 211, until the lever 209 interacts with a rigid surface 240 of the engine (not shown). Contact between the lever 209 and the rigid surface 240 is maintained by the tensioner spring 228 (and any oil pressure when present). The tensioner arm 201 continues to pivot as the tensioner 203 position continues to adjust in response to a variety of dynamic loads, such as, but not limited to chain tension, chain runout, sprocket runout, supply pressure and other loads. The lever 209 also interacts with the surface 208 opposite the chain sliding surface 202, causing the tensioner arm 201 to pivot about the first pivot point 205, such that tension is applied relative to the chain 260 via the chain sliding surface 202 of the tensioner arm 201. It should be noted that the position of the piston 227 relative to the housing 220 of the hydraulic tensioner 203 is maintained through the spring 228 and the hydraulic pressure in the pressure chamber 230. Teeth may be added to the outer circumference of the piston 227 as well as circlip to limit the movement of the piston 227 inwards towards the housing 220.

FIG. 2B illustrates the hydraulic tensioner device 200 when tensioning a new chain. It should be noted that less pivoting of the tensioner arm 201 relative to the chain 260 is required as opposed to a worn chain which has increased slack and requires additional tension to maintain.

FIG. 2C illustrates the hydraulic tensioner device 200 when tensioning a worn chain. It should be noted that the lever 209 is further rotated about the second pivot point 211 in order to allow further inward rotation of the tensioner arm 201 about the first pivot point 205 relative to the worn chain, as the worn chain is stretched and looser than a new chain.

FIG. 2D illustrates a top view of the hydraulic tensioner device 200 of FIG. 2A. In this view it can be clearly seen that the hydraulic tensioner 203 fits within the arc defined by the surface 208, opposite the chain sliding surface 202 and can be inside the body of the tensioner arm 201. In this case, the tensioner 203 is mounted within the hollow arc section and parallel to the chain sliding face 202 of the tensioner arm 201. More specifically, mounting options of a hydraulic tensioner device 200 can include, for example, a split arm design where the tensioner 203 of the hydraulic tensioner device 200 fits between tensioner arm plates 262 and 264. In this example the body of the tensioner arm 201 can define a hollow section formed between the plates 262 and 264 (under the chain sliding surface 202) and pivot points 205 and 211 to receive the tensioner 203 therein.

FIG. 2G shows an alternate embodiment of the hydraulic tensioner device 200 in which the hydraulic tensioner 203 is replaced with tensioner 250, which is a no oil feed tensioner.

The no oil feed tensioner 250 has a sealed housing 262 which does not require an ongoing supply of oil feed to be operated. Therefore, in this embodiment, the first pivot point 205 does not contain a banjo oil feed bolt 275 and rod 221 containing passage 222 is replaced with a solid rod 264.

The sealed housing 262 has a closed end bore 265 with a first open end 265a and a second closed end 265b. The first open end 265a is sealed with O-rings or other seal design 261 to prevent leaks of hydraulic fluid from the tensioner 250, while still allowing movement of a piston 227 within the closed end bore 265 of the housing 262.

The closed end bore 265 slidably receives a hollow piston 227. The hollow piston 227 has a first end 227a, a second end 227b, an inner hollow 227c, and an outer circumference 227d. The second end 227 of the hollow piston 227 is received within the open ended bore 225. The outer circumference 227d of the first end 227a of the hollow piston 227 has an outer circumferential groove 231. The hollow piston 227 contains an inlet check valve 263 within the inner hollow 227c of the piston 227 along with spring 228. The first end of the spring 228a is in contact with the inlet check valve 263 and the second end 228b of the spring 228 is in contact with second closed end 225b. A low pressure chamber or reservoir 267 is present between the check valve 263 and the inner hollow 227c of the piston 227. A high pressure chamber 282 is present between the second end 265b of the bore 265 and the check valve 263. Oil can circulate from the high pressure chamber 282 to the low pressure chamber 267 around a clearance between the outer circumference 227d of the piston 227 via hole 281. The check valve 263 allows the flow of fluid from the low pressure chamber or reservoir 267 to the high pressure chamber 282 when the high pressure chamber pressure 282 is too low, which is for very brief periods when the hollow piston 227 is extending from the housing 262.

A lever 209 is pivotably attached to the second end 201b of the tensioner arm 201 at a second pivot point 211. The first end 209a of the lever 209 interfaces with a surface 240 of the engine or any other rigid surface where the tensioner arm 201 is contained. The second end 209b of the lever 209 has a closed end bore 232 for receiving the first end 227a of the piston 227. The first end 227a of the piston 227 can be captured and maintained within the closed end bore 232 of the lever 209 by the outer circumferential groove 231. Preferably, the first end 227a of the piston 227 is allowed a small amount of play within the closed end bore 232 of the lever 209.

A tension force can be applied to the tensioner arm 201 through mechanical lever 209, rotating the lever 209 about the second pivot point 211. When a force is exerted on the chain sliding surface 202 of tensioner arm 201 by the chain 260, the movement of the tensioner arm 201 moves the piston 227 of the no oil feed tensioner 250 relative to the housing 262, such that the movement of the piston 227 and the associated interaction of the first end 227a of the piston 227 with the closed end bore 232 of the lever 209, causes the lever 209 to pivot about the second pivot point 211, until the lever 209 interacts with a rigid surface 240 of the engine (not shown). Contact between the lever 209 and the rigid surface 240 is maintained by the tensioner spring 228 (and any oil pressure when present). The tensioner arm 201 continues to pivot as the tensioner 203 position continues to adjust in response to a variety of dynamic loads, such as, but not limited to chain tension, chain runout, sprocket runout, supply pressure and other loads. The lever 209 also interacts with the surface 208 opposite the chain sliding surface 202, causing the tensioner arm 201 to pivot about the first pivot point 205, such that tension is applied relative to the chain 260 via the chain sliding surface 202 of the tensioner arm 201. It should be noted that the position of the piston 227 relative to the housing 262 of the no oil feed tensioner 250 is maintained through the spring 228 and the maintained hydraulic pressure in the high pressure chamber 282. Teeth may be added to the outer circumference of the piston 227 as well as circlip to limit the movement of the piston 227 inwards towards the housing 262.

An advantage of using the illustrated lever 209 in the above embodiments is that lever 209 can provide a variety of ratios of movement with respect to the tensioner arm 201 so that little movement of the lever 209 will cause a larger movement of the tensioner arm 201. For example, the ratio of the movement of tensioner arm 201 to the lever 209 may be 2:1. By using layout shown in FIGS. 2A-2G, the space required for the hydraulic tensioner device 200 is reduced, since the tensioner arm 201 and hydraulic tensioner 203 or no oil feed tensioner 250 are connected together, thus requiring less space for the hydraulic tensioner device 200. Furthermore, in the embodiment with the no oil feed tensioner 250, a reservoir to supply oil to the tensioner device 200 is not required and the space efficiency of the hydraulic tensioner device 200 is increased.

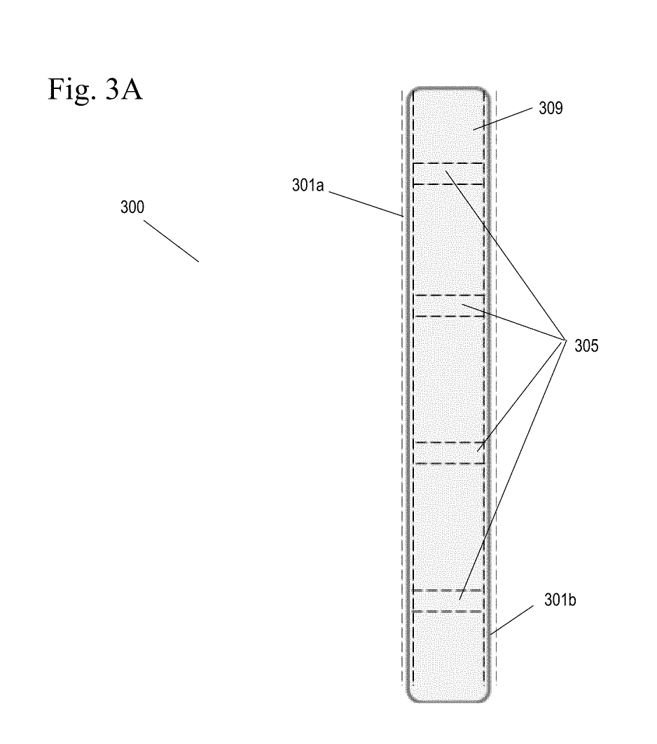

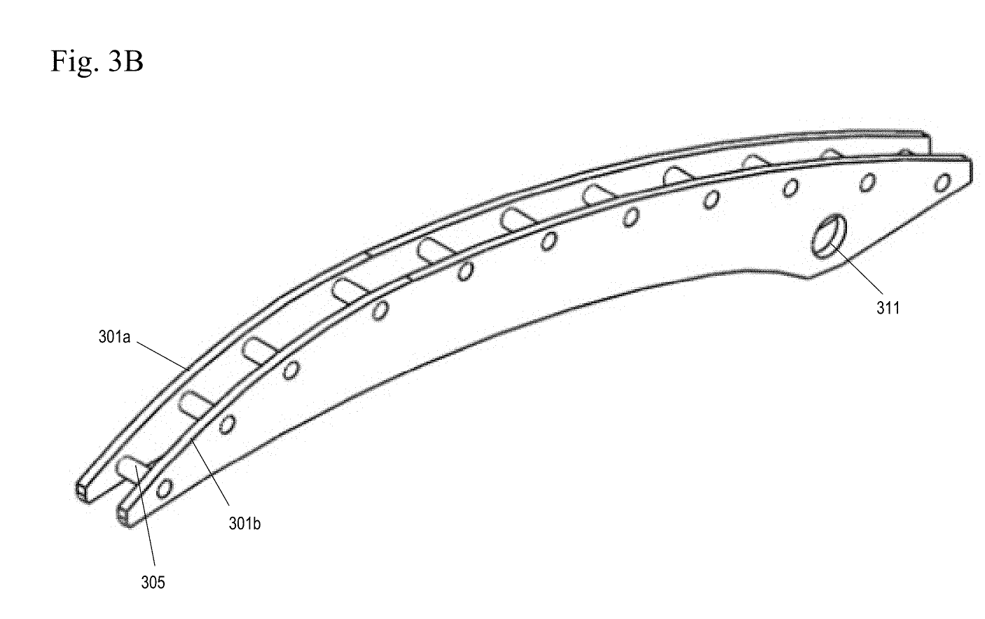

FIG. 3A illustrates another example embodiment of a tensioner device 300 with a tensioner arm 301 that includes a laminate face 309 which acts as a chain sliding surface in which the chain contacts. FIG. 3B shows a side view of the tensioner arm 301 and the laminate face 309 removed.

In this embodiment the tensioner arm 301 is formed of two plates 301a and 301b rigidly connected through pins 305. The plates 301a, 301b may be made of steel, plastic, nylon or other materials. Once of the plates 301a of the tensioner arm 301 may be made of a different material than the other plate 301b of the tensioner arm 301. The pins 305 can we welded to the plates 301a, 301b or riveted to the plates 301a, 301b. At one end of the steel plates 301a and 301b is a pivot point 311 which can receive a bolt or an oil feed banjo bolt 275. The laminate face 309 can be formed of a polymer material, or aluminum, or other metals. This exemplary embodiment also provides for a space-efficient tensioner device 300 by disposing the tensioner (not illustrated) within the tensioner arm 301 between the two plates 301a and 301b requiring less space for the overall tensioner device 300.

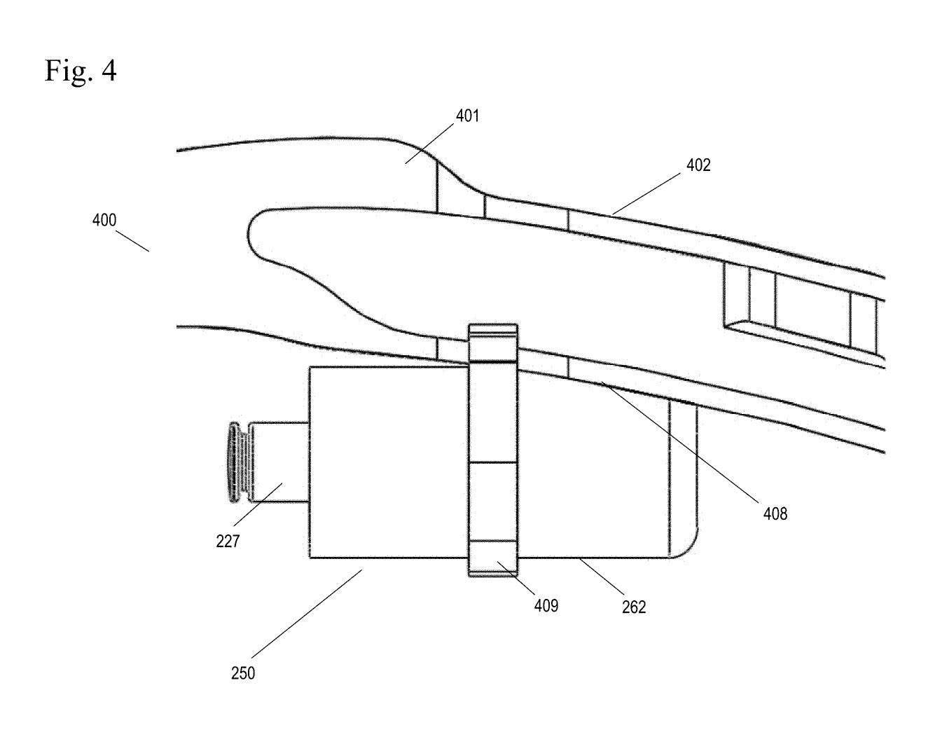

FIG. 4 illustrates another embodiment of a hydraulic tensioner device 400 in which a no oil feed tensioner, such as tensioner 250 is strapped to an arcuate surface 408 of the tensioner arm 401, opposite the chain sliding surface 402 with a strap 409. As in previous embodiments, the piston 227 of the tensioner 250 contacts a pivoting lever 209, which can cause the pivoting lever 209 to pivot and come into contact with a surface of the engine and the arcuate surface 408 of the tensioner arm 401, which in turn causes the tensioner arm 401 to pivot about a first pivot point to move the tensioner arm 401 toward the chain (not illustrated) being tensioned.

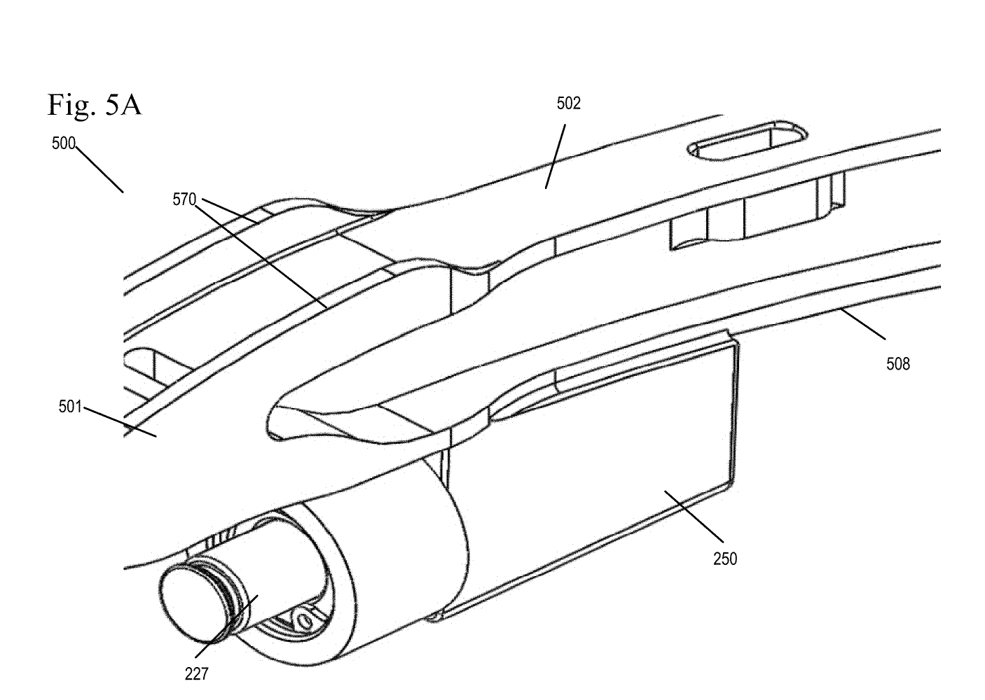

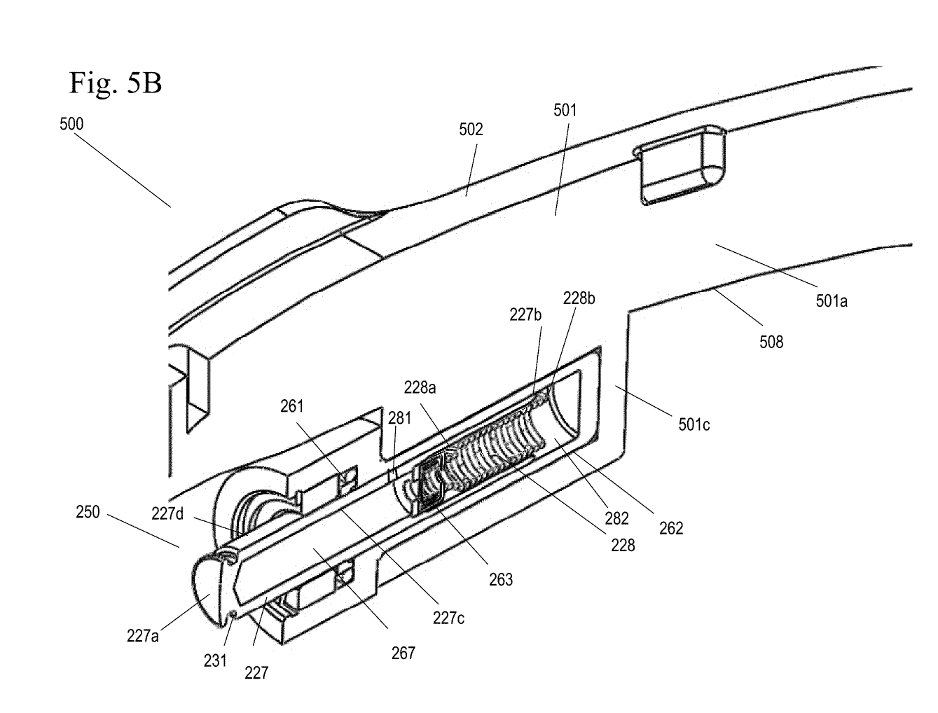

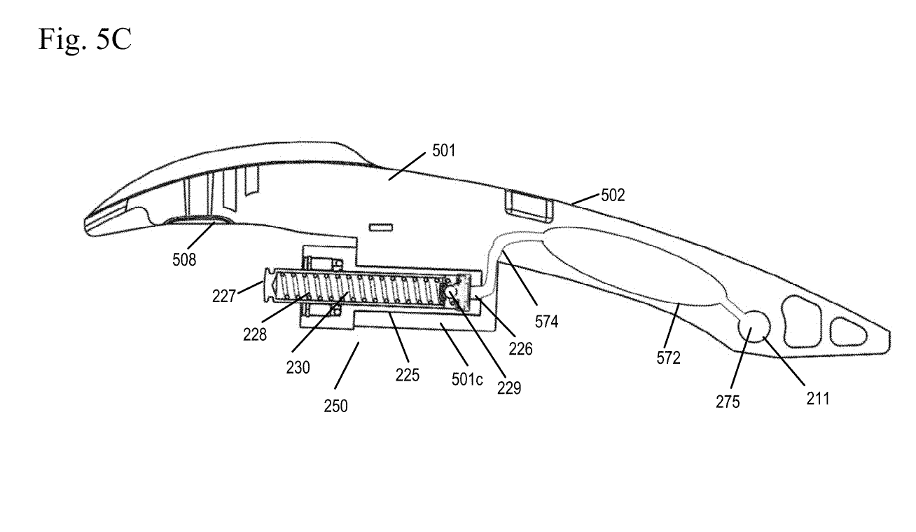

FIG. 5A-5B illustrates another example embodiment of a hydraulic tensioner device 500. The tensioner of the hydraulic tensioner device 500 is a no oil feed tensioner, such as no oil feed tensioner 250. The no oil feed tensioner 250 is formed or fitted within a body portion 501c of the tensioner arm 501. More specifically, the tensioner arm 501, on a surface 508 opposite the chain sliding surface 502 includes a housing 262 formed integrally with the body portion 501c of the tensioner arm 501. Within the housing 262, is closed end bore 265 which slidably receives a hollow piston 227. The hollow piston 227 has a first end 227a, a second end 227b, an inner hollow 227c, and an outer circumference 227d. The second end 227 of the hollow piston 227 is received within the closed ended bore 265. The outer circumference 227d of the first end 227a of the hollow piston 227 has an outer circumferential groove 231. The hollow piston 227 contains an inlet check valve 263 within the inner hollow 227c of the piston 227 along with spring 228. The first end of the spring 228a is in contact with the inlet check valve 263 and the second end 228b of the spring 228 is in contact with second closed end of the bore 265b. A low pressure chamber or reservoir 267 is present between the check valve 263 and the inner hollow 227c of the piston 227. A high pressure chamber 282 is present between the second end 265b of the bore 265, the spring 228 and the check valve 263. Oil can circulate from the high pressure chamber 282 to the low pressure chamber 267 around a clearance between the outer circumference 227d of the piston 227 via hole 281. The check valve 263 allows the flow of fluid from the low pressure chamber or reservoir 267 to the high pressure chamber 282 when the high pressure chamber pressure 282 is too low, which is for very brief periods when the hollow piston 227 is extending from the housing 262.

The housing 262 can be formed by the body portion 501c of the tensioner arm 501 by press-fitting a first half 501a of a tensioner arm and a second half (not shown) together from two molded halves as shown in FIG. 5A or can be over-molded to form a tensioner arm 501. Alternatively, the no oil feed tensioner 250 can be press fit into an existing cavity molded into the tensioner arm or the tensioner arm could be molded around tensioner 250 to capture the tensioner, for example as shown in FIG. 5B.

FIG. 5C shows a cross-sectional view of a tensioner arm 501 of FIG. 5A with hydraulic tensioner 203 received within the body potion 501c of the tensioner arm 501. The tensioner is a hydraulic tensioner, such as tensioner 203 which receives oil from a reservoir 572 which is in fluid communication via line 574 with a first pivot point 211 with oil feed banjo bolt 275. The reservoir 572 is molded into the tensioner arm 501.

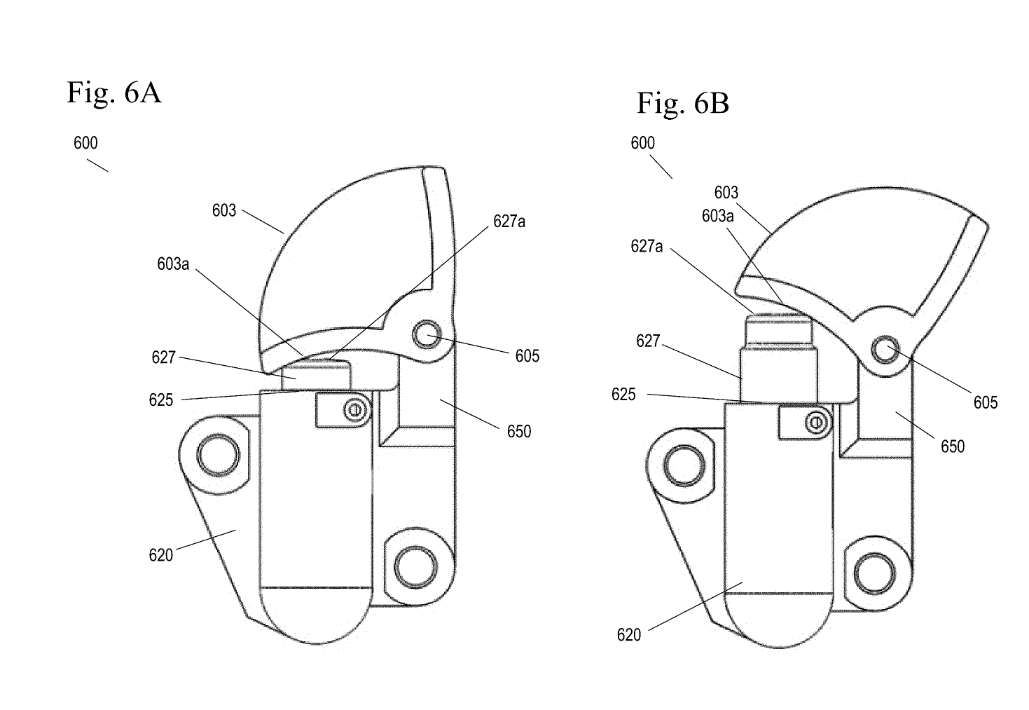

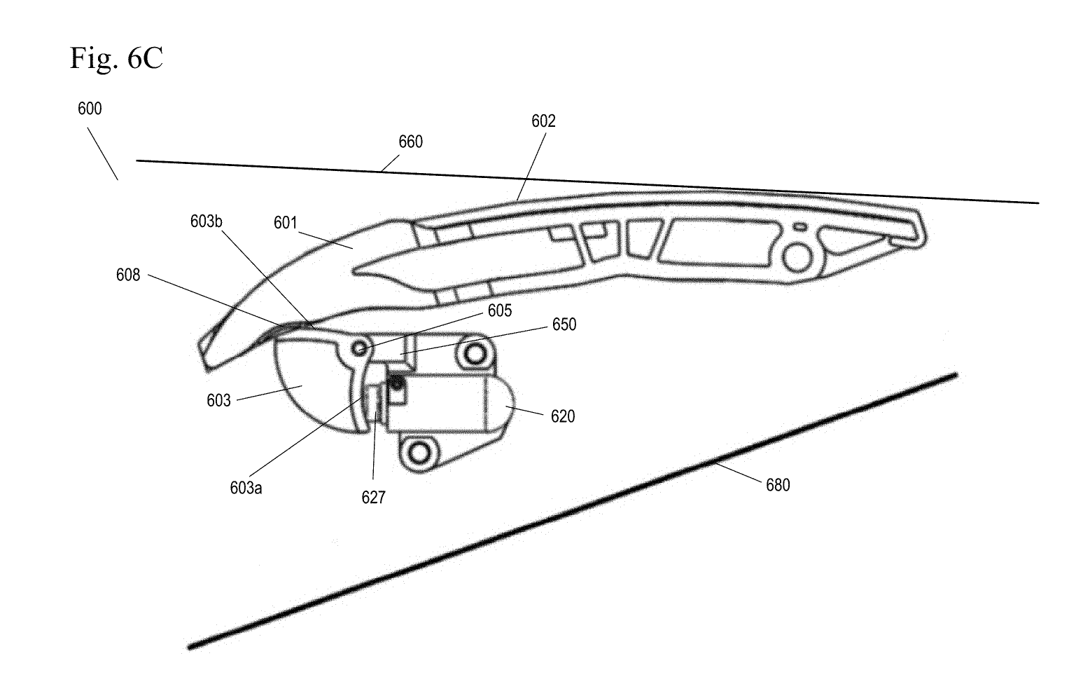

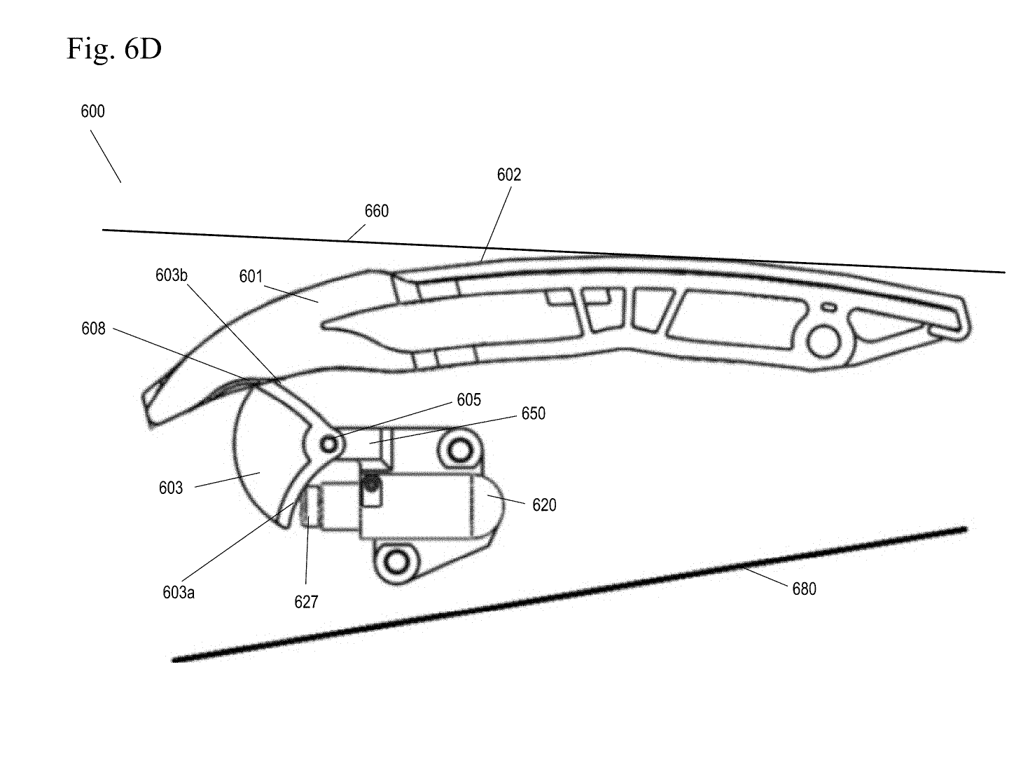

FIGS. 6A-6D illustrate another embodiment of a hydraulic tensioner device 600. A pivoting cam lever 603 is rotatably attached to an extension 650 of a hydraulic tensioner housing 620 at a pivot point 605. The pivoting cam lever 603 has a first edge 603a and a second edge 603b.

Within a bore 625 of the hydraulic tensioner housing 620, a piston 627 is received. The piston 627 has a first end 627a and a second end (not shown). The bore 625 of the hydraulic tensioner housing 620 and the pivot point 605 are parallel.

The first end 627a of the piston 627 is contact with the first edge 603a of the pivoting cam lever 603. The second edge 603b of the pivoting cam lever 603 contacts a surface 608 of the tensioner arm 601 which is opposite the chain sliding surface 602.

When the piston 607 is biased outwards or away from the housing 620, by a spring and/or hydraulic pressure, the first end 627a of the piston 627 applies a force to the first edge 603a of the pivoting cam lever 603. The linear force of the piston 627 applied to the pivoting cam lever 603 is converted to a rotational force which moves the pivoting cam lever 603 less than 25 degrees. The rotation of the pivoting cam lever 603 forces the second edge 603b of the pivoting cam lever 603 to contact a surface 608 of the tensioner arm 601 which is opposite the chain sliding surface 602 of the tensioner arm to rotate the tensioner arm 601 into contact with the chain 660.

While the pivoting cam lever 603 is shown as being semicircular, other shapes may also be used that allow the force applied by piston 627 to be used to move the tensioner arm 601 and tension the chain.

It should be noted that since a worn chain requires additional tensioning, the extension of the piston 627 from the housing 620 will be greater than during tensioning of a new chain. The tensioning of a worn chain is shown in FIGS. 6B and 6D and the tensioning of a new chain is shown in FIGS. 6A and 6C.

It should be noted that due to the shape of the pivoting cam lever 603 a small amount of movement of the piston 627 is required to move the tensioner arm 601 via the pivoting cam lever 603 to tension the worn chain. An advantage of using the illustrated cam lever 603 is that cam lever 603 can provide a variety of ratios of movement with respect to the tensioner arm 601 so that little movement of the cam lever 603 will cause a larger movement of the tensioner arm 601. For example, the ratio of the movement of tensioner arm 601 to the lever may be 2:1. By using layout shown, the space required for the hydraulic tensioner device 600 is reduced.

The pivoting cam lever 603 can be made of any material and shape that will perform the intended purposes as described herein, and that can be attached at a pivoting point with respect to the tensioner arm 601.

The hydraulic tensioner device 600 can be attached to an engine block, front cover or other rigid surface 680 of the engine through bolts or other fastening devices through holes 611 of the housing 620.

By using a pivoting cam lever 603 which is biased by a piston 627 of a hydraulic tensioner to move the tensioner arm 601, the amount of space required for the hydraulic tensioner device including the tensioner arm is reduced.

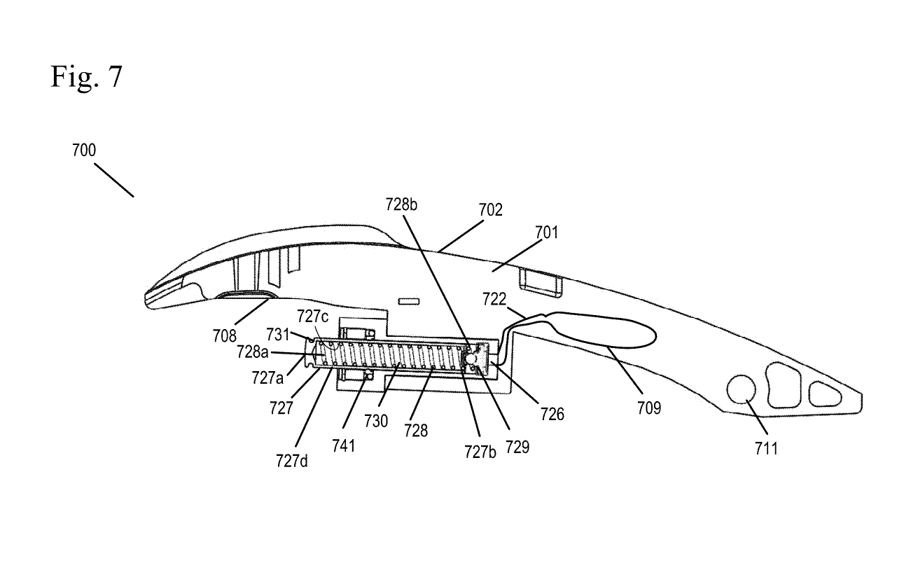

FIG. 7 shows a tensioning device of another embodiment. Similar to the embodiment illustrated in FIG. 5C, a reservoir 709 can be molded into a tensioner arm 701. The reservoir 709 has a passage 722 extending between the reservoir 709 and the inlet 726 of a bore 725 housing a piston 727. The reservoir 709 maintains hydraulic pressure within a pressure chamber 730 formed between piston 727, a spring 728 and the bore 725 within the housing 720.

The bore 725 with a first open end 725a and a second closed end 725b in fluid communication with inlet 726. A hollow piston 727 is received within the open ended bore 725. The hollow piston 727 has a first end 727a, a second end 727b, an inner hollow 727c, and an outer circumference 727d. The first end 727a of the piston 727 has a circumferential groove 731. The second end 727b of the hollow piston 727 is received within the open ended bore 725. Received within the inner hollow 727c of the piston 727 is a spring 728 which biases the piston 727 outwards or away from the second closed end 725b of the bore 725. The spring 728 has a first end 728a and a second end 728b. The first end 728a of the spring 728 is received within the inner hollow 727c of the hollow piston 727. The second end 728b of the spring 728 is received within the second closed end 725b of the bore 725 and is adjacent an inlet check valve 729. The inlet check valve 729 prevents fluid from flowing back to the reservoir 709 and allow fluid to flow to a hydraulic pressure chamber 730 formed between the hollow piston 727, the open ended bore 725 and the inlet check valve 729.

Within the housing 720, seals 741, such O-rings, may be used to seal and surround the outer circumference 727d of the piston 727 as the piston 727 moves outwards or away from the housing 720.

The first end 727a of the piston 727 contacts a lever (not shown) similar to lever and contact shown in FIGS. 2A-2E. The lever is pivotably attached to the second end 701b of the tensioner arm 701 at a pivot point 711. A first end of the lever interfaces with a portion of the engine. The second end of the lever has a closed end bore for receiving the first end 727a of the piston 727. The first end 727a of the piston 727 can be captured and maintained within the closed end bore of the lever by the outer circumferential groove 731. Preferably, a piston 727 is allowed a small amount of play within the closed end bore of the lever.

When a force is exerted on the chain sliding surface of tensioner arm 701 by the chain (not shown), the movement of the tensioner arm 701 moves the piston 727 of the tensioner 703 relative to the housing 720 of the tensioner arm 701, such that the movement of the piston 727 and the associated interaction of the first end 727a of the piston interacts with the closed end bore 732 of the lever (not shown), pivoting the lever until the lever interacts with a rigid surface of the engine (not shown). Once the lever interacts with the rigid surface, contact between the lever and the rigid surface is maintained by the tensioner spring 728 (and any oil pressure when present). The tensioner arm 701 continues to pivot as the tensioner 703 position continues to adjust in response to a variety of dynamic loads, such as, but not limited to chain tension, chain runout, sprocket runout, supply pressure and other loads. The lever also interacts with the surface opposite the chain sliding surface 702, causing the tensioner arm 701 to pivot about the first pivot point (not shown), such that tension is applied relative to the chain via the chain sliding surface 702 of the tensioner arm 701. It should be noted that the position of the piston 727 relative to the housing 720 of the no oil feed tensioner 703 is maintained through the spring 728 and the maintained hydraulic pressure in the pressure chamber 267. Teeth may be added to the outer circumference of the piston 727 as well as circlip to limit the movement of the piston 727 inwards towards the housing 720.

In this embodiment, the reservoir 709 is not connected to a hydraulic supply from the engine, but is instead filled at installation into the engine and is self-contained.

Accordingly, it is to be understood that the various embodiments of the present invention herein described are merely illustrative of the application of the principles of the invention. Reference herein to details of the illustrated embodiments is not intended to limit the scope of the claims, which themselves recite those features regarded as essential to the overall invention.

What is claimed is:

1. A hydraulic tensioner device for an internal combustion engine comprising:
a tensioner arm comprising:
a body having a first end, a second end, a chain sliding surface and a surface opposite the chain sliding face;
a pivot at the first end or the second end of the body; and
an oil feed banjo bolt feed at the other of the first end or second end of the body;
a hydraulic tensioner pivotably attached to the pivot and the oil feed banjo bolt and adjacent the surface opposite the chain sliding face, wherein the hydraulic tensioner receives supply fluid from the oil feed banjo bolt, the hydraulic tensioner comprising:
a housing with a bore;
a hollow piston having a first end and a second end, slidably received within the bore; and
a spring received within the bore of the housing and the hollow piston biasing the hollow piston outwards from the bore of the housing.

2. The hydraulic tensioner device of claim 1, wherein a rod containing a passage is present between the banjo bolt and the hydraulic tensioner.

3. The hydraulic tensioner device of claim 1, further comprising a rotatable lever attached to the pivot with a first end receiving the first end of the hollow piston and a second end interacting with a surface of the internal combustion engine wherein the hollow piston biases the rotatable lever into contact with the surface opposite the chain sliding surface, biasing the tensioner arm into contact with a chain.

4. The hydraulic tensioner device of claim 1, wherein the body of the tensioner comprises a first plate, a second plate rigidly connected to the first plate through pins and the chain sliding surface is a laminate surface.

5. The hydraulic tensioner device of claim 1, wherein the hydraulic tensioner further comprises an inlet check valve received within the hollow piston and adjacent the spring.

6. The hydraulic tensioner device of claim 1, further comprising a first pivot at the first end of the body and a second pivot at the second end of the body.

7. The hydraulic tensioner device of claim 6, wherein one of the first pivot or the second pivot contains the oil feed banjo bolt.

8. A hydraulic tensioner device for an internal combustion engine comprising:
a tensioner arm comprising: a body having a first end, a second end, a chain sliding surface, a surface opposite the chain sliding face, the body providing a housing having a bore; and a pivot at the first end or the second end of the body; and
a hydraulic tensioner comprising: a hollow piston having a first end and a second end, slidably received within the bore of the housing of the body of the tensioner; and a spring received within the bore of the housing and the hollow piston biasing the hollow piston outwards from the bore of the housing.

9. The hydraulic tensioner device of claim 8, further comprising a rotatable lever attached to the pivot with a first end receiving the first end of the hollow piston and a second end interacting with a surface of the internal combustion engine, wherein the hollow piston biases the rotatable lever into contact with the surface opposite the chain sliding surface, biasing the tensioner arm into contact with a chain.

10. The hydraulic tensioner device of claim 8, wherein the hydraulic tensioner further comprises an inlet check valve received within the hollow piston and adjacent the spring.

11. The hydraulic tensioner device of claim 8, further comprising a reservoir formed with the body of the tensioner arm.

12. The hydraulic tensioner device of claim 11, wherein the reservoir is not connected to engine oil supply.

13. The hydraulic tensioner device of claim 8, wherein the chain sliding surface further comprises side rails.

14. A hydraulic tensioner device for an internal combustion engine comprising:
a tensioner arm comprising: a body having a first end, a second end, a chain sliding surface, a surface opposite the chain sliding face; and a pivot at the first end or the second end of the body;
a hydraulic tensioner rigidly attached to the internal combustion engine, the hydraulic tensioner comprising:
a housing having an extension and a bore, the bore and the extension being parallel;
a hollow piston having a first end and a second end, slidably received within the bore of the housing;
a spring received within the bore of the housing and the hollow piston biasing the hollow piston outwards from the bore of the housing; and
a rotatable cam lever pivotably attached to the extension, the cam lever having a first edge for contacting the first end of the hollow piston and a second end for contacting the surface opposite the chain sliding surface of the tensioner arm at the first end or second end with the pivot, the rotatable cam lever being rotatable by the hollow piston, such that the rotatable cam lever biases the tensioner arm to pivot into contact with a chain.

15. A hydraulic tensioner device for an internal combustion engine comprising:
a tensioner arm comprising: a body having a first end, a second end, a chain sliding surface and a surface opposite the chain sliding face; a pivot at the first end or the second end of the body; and
a hydraulic tensioner rigidly attached to the surface opposite the chain sliding face of the body of the tensioner arm via a strap.
